(19) United States
(12) Patent Application Publication
(10) Pub. No.: US 2011/0314931 A1
(43) Pub. Date: Dec. 29, 2011

(54) ELECTROMAGNETIC FLOW METER

(76) Inventors: Takuya Iijima, Tokyo (JP); Satoshi Hojyo, Tokyo (JP)

(21) Appl. No.: 13/157,820

(22) Filed: Jun. 10, 2011

(30) Foreign Application Priority Data
Jun. 28, 2010 (JP) 2010-146948

(51) Int. Cl. G01F 1/58

(52) U.S. Cl. 73/861.12; 73/861.11

(57) ABSTRACT

An apparatus is disclosed that includes a measuring pipe comprising an inner layer and a non-magnetic outer layer; an electric flow meter electrically connected to the measuring pipe and operable to measure the flow of a material within the pipe; an insert comprising non-magnetic material exposed to the interior space of the measuring pipe and in electrical connection with the outer layer of the measuring pipe, wherein the insert is operable to provide a common ground between the material within the pipe and the flow measuring device.

### CROSS-REFERENCE TO RELATED APPLICATIONS

This application is based upon and claims the benefit of priority from Japanese Patent Application No. 2010146948, filed on Jun. 28, 2010, the entire contents of which are incorporated herein by reference.

### TECHNICAL FIELD

The present disclosure relates to an electromagnetic flow meter, and more particularly to an electromagnetic flow meter in which an earthing structure is used to measure fluid flow.

### BACKGROUND

A measuring pipe of a conventional electromagnetic flow meter detector was made such that, as shown in FIG. 4, lining material 22 is lined from the inner face of a measuring pipe 21 to the halfway position in the radial direction of the end face of a measuring pipe flange 21a, and a lining flared portion 22a along the measuring pipe flange 21a is pressed by an earth ring 23 which is screwed to the measuring flange 21a.

However, in this conventional technology, if the bore diameter of the measuring pipe 21 becomes large, it was difficult to seal between the earth ring 23 and the lining flared portion 22a, unless the earth ring is made thicker so as to press the lining flared portion 22a sufficiently.

For this reason, there was a problem that as cutting work is required from a stainless material with a larger size, if the bored diameter becomes larger, the earth ring becomes expensive from both sides of the material cost and the processing cost.

Typically, the earth ring is named generally for the ring shaped plate and foil, and the earth electrode and so on, and usually, means one which lies between the electromagnetic flow meter detector and the other side pipe.

In order to solve the problem of such the earth ring 23, there is an electromagnetic flow meter constructed as shown in FIG. 5 such that an earth electrode 28 is mounted liquid-tightly on the surface of the lining material 22 at the position near the pipe terminal of the measuring pipe 21, and a lead wire 25 connected to the earth electrode 28 is made to penetrate through the lining material 22, and is led out to the outer circumference face along the end face of the measuring pipe flange 21a via the space between the lining material 22 and the inner face of the measuring pipe 21.

In an electromagnetic flow meter using an earth ring, generally, a uniform magnetic field is applied from the direction orthogonal to the pipe axis of the measuring pipe at the central portion of the measuring pipe, and detecting electrodes are provided at facing positions of the inner wall face of the measuring pipe which are orthogonal to both the magnetic field and the pipe axis.

For this reason, if the distances between the earth ring provided at both end portions of the measuring pipe and a pair of the detecting electrodes become longer, a problem is generated that earth current flows via the pipe and the liquid to be measured and noise is superimposed on the detection signal which is taken out from between the detecting electrodes.

The noise may have a profound effect if the electric conductivity of the liquid to be measured falls.

Consequently, an electromagnetic flow meter is disclosed with the earthing structure in which the earth ring and a still another earth electrode are prepared, and as this earth electrode, a pair of ring shaped electrodes or a plurality of bar type electrodes are provided at the positions in the uniform magnetic field so as to form the earth electrode

In the case of the construction that the earth potential is made using the earth electrode, though it is possible to eliminate the use of the conventional earth ring, as a construction is used in which the earth electrode which is made to penetrate through the lining material and the lead wire connected to this earth electrode are lead out between the measuring pipe and the lining material along the measuring pipe, there is a problem that the construction becomes complicated because special sealing means is required for sealing at the liquid contacting portion of the earth electrode and sealing at the route of the lead wire to be connected to this.

Similarly, as with an earth electrode with a construction to penetrate through the measuring pipe, there is a problem that the construction becomes complicated because highly-reliable sealing means is required in the same way as the detecting electrode portion for sealing at the liquid contacting portion of the earth electrode.

### SUMMARY

To achieve the above-described object, an electromagnetic flow meter according to the present disclosure includes, a measuring pipe formed with non-magnetic metal to flow liquid to be measured having flanges at both end portions thereof, a lining material which is formed by lining rubber or resin on an inner face of the measuring pipe, a pair of detecting electrodes which are provided orthogonally to the pipe axis of the measuring pipe to face to each other at the inner faces of the pipe wall of the measuring pipe so as to make contact with the liquid to be measured flowing in the measuring pipe, a pair of exciting coils which are provided on an outer wall of the measuring pipe to generate magnetic field in the direction orthogonal to both the pipe axis and an axis connecting the pair of the detecting electrodes, and a convex portion made of non-magnetic metal with a height not less than a thickness of the lining material provided integrally on an inner wall of the measuring pipe at a position of the flange, wherein the lining material is lined so that the convex portion contacts with the liquid, and the convex portion is made as an earth electrode.

An apparatus is also disclosed that includes a measuring pipe comprising an inner layer and a non-magnetic outer layer; an electric flow meter electrically connected to the measuring pipe and operable to measure the flow of a material within the pipe; an insert comprising non-magnetic material exposed to the interior space of the measuring pipe and in electrical connection with the outer layer of the measuring pipe, wherein the insert is operable to provide a common ground between the material within the pipe and the flow measuring device. The electric flow meter includes pair of electrodes arranged opposite to one along the inner layer of the measuring pipe so as to make contact with the material to be measured within the measuring pipe; and a pair of exciting coils arranged on the outer layer of the measuring pipe operable to generate magnetic field. The measuring pipe includes flanges located at ends of the measuring pipe and wherein the insert is located at a position corresponding to the flanges. The insert is in physical contact with the interior space of the measuring pipe and an outer layer of the measuring pipe. The inner layer of the measuring pipe comprises a resin. The insert has a thickness that is substantially the same as a thickness of the lining. The apparatus includes a boss formed in the inner surface of the measuring pipe and in physical contact with the outer layer wherein the insert is screwed into the boss.

A method is disclosed that includes generating a magnetic field in an orthogonal direction to a pipe axis, the pipe comprising an inner layer and an outer layer; detecting changes in the generated magnetic field caused by material flow through the pipe; electrically connecting the material in the interior of the pipe to the outer layer of the pipe using at least one earth electrode insert that is fixed within the inner layer of the pipe wherein the insert is configured to be in physical contact with the interior space of the pipe and the outer layer of the pipe, and determining the rate of flow of material within the pipe using the detected changes in the generated magnetic field. Generating a magnetic field comprises operating a pair of exciting coils provided on an outer wall of the pipe in the direction orthogonal to the pipe axis. Detecting changes in the generated magnetic field caused by material flow through the pipe comprises arranging a pair of detecting electrodes orthogonally to the axis of the pipe to face to each other at the inner faces of the measuring pipe so as to make contact with the material to be measured flowing in the measuring pipe. The insert includes a boss and a screw, wherein the screw is screwed into the boss and is physical contact with the material in the pipe and wherein the boss is in physical contact with the outer layer of the pipe. The pipe includes first and second flanges located at first and second ends of the pipe and wherein at least one insert is provided at a location corresponding to the flanges.

An electromagnetic flow meter is disclosed that includes a measuring pipe formed with non-magnetic metal having flanges at the pipe's ends; a lining material formed on an inner face of the measuring pipe; a pair of detecting electrodes provided orthogonally to the axis of the measuring pipe to face to each other at the inner faces of the measuring pipe so as to make contact with the liquid to be measured flowing in the measuring pipe; a pair of exciting coils provided on an outer wall of the measuring pipe operable to generate magnetic field in the direction orthogonal to both the pipe axis and an axis connecting the pair of the detecting electrodes; and a convex portion made of non-magnetic metal with a height not less than a thickness of the lining material provided integrally on the inner wall of the measuring pipe at a position of the flange; wherein the lining material is lined so that the convex portion contacts with the liquid, and the convex portion comprises an earth electrode. The convex portions are provided at the end portions of the measuring pipe, and a groove is processed at an outer circumference portion of the convex portion except at a fluid contacting face so as to lock the lining material. The convex portion includes a boss with a height not more than a thickness of the lining material, a screw, and a screw hole processed at an inner face of the boss; wherein the screw comprises an earth electrode and is secured in the screw hole of the boss from the inner face side of the measuring pipe so as to lock the lining material. The lining material of the measuring pipe includes a resin. The lining material of the measuring pipe includes a plastic. The convex portion can be the sole means for electrically connecting the fluid to be measured to the non-magnetic metal portion of the measuring pipe.

### BRIEF DESCRIPTION OF THE DRAWINGS

FIG. 1 illustrates an explanatory diagram of an earthing structure of a first embodiment of an electromagnetic flow meter of the present disclosure.

FIG. 2 illustrates an explanatory diagram of an earthing structure of a second embodiment of an electromagnetic flow meter of the present disclosure.

FIG. 3 illustrates an explanatory diagram of an earthing structure of a third embodiment of an electromagnetic flow meter of the present disclosure.

FIG. 4 illustrates a cross-section of a section of a conventional electromagnetic flow meter provided with an earth ring.

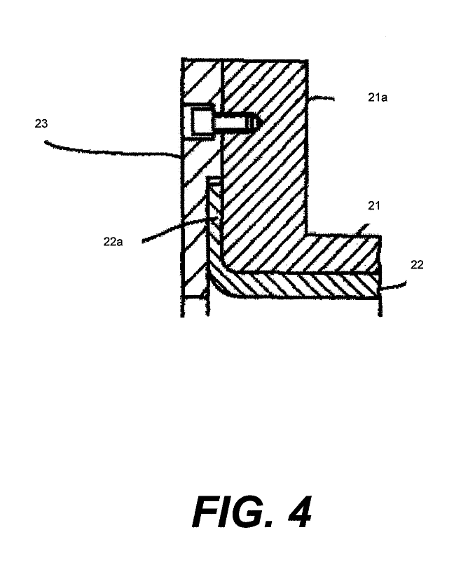

FIG. 5 illustrates a cross-section of a section of a electromagnetic flow meter provided with a conventional earth electrode.

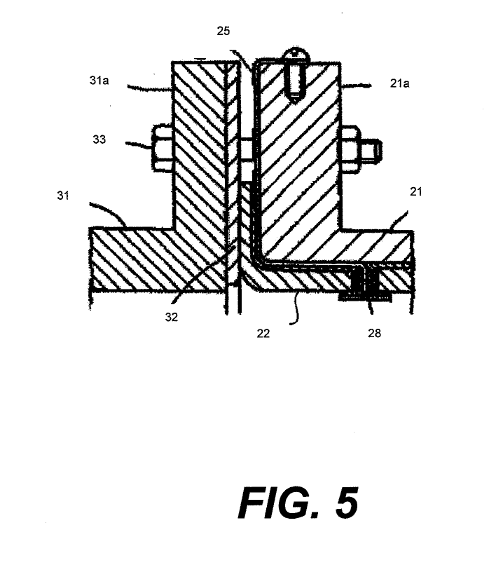

### SPECIFICATION

Hereinafter, embodiments of the present disclosure will be described with reference to the drawings.

### First Embodiment

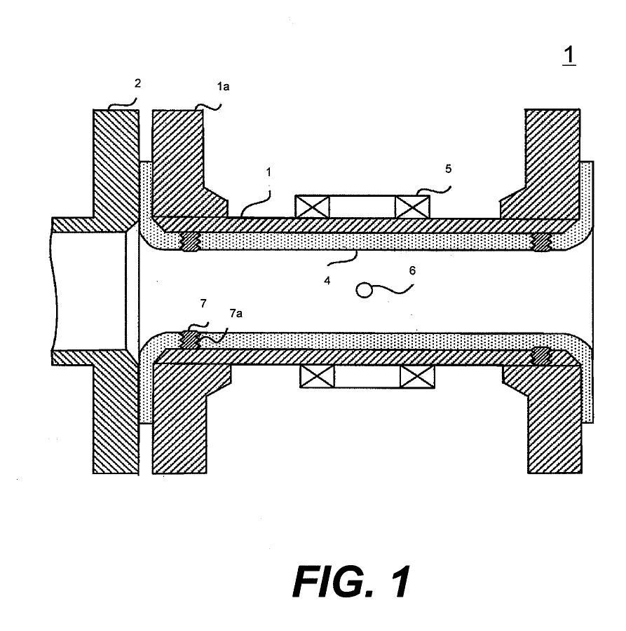

FIG. 1 shows a construction of an electromagnetic flow meter of a first embodiment of the present disclosure. FIG. 1 shows a sectional view of an electromagnetic flow meter detector when cut in the pipe axis direction at the center of the pipe diameter of a measuring pipe 1.

The electromagnetic flow meter of the present disclosure is provided with the measuring pipe 1 formed with non-magnetic metal to flow a liquid to be measured which has flanges 1a at both end portions, a lining material 4 which is formed by lining a resin, plastic, or other insulative material on the inner face of the measuring pipe 1, a pair of detecting electrodes 6 which are provided orthogonally with the pipe axis of the measuring pipe 1, to face to each other at the inner faces of the pipe wall of the measuring pipe 1, and so as to contact with the liquid to be measured flowing in the measuring pipe 1, and a pair of exciting coils 5 which are provided on the outer wall of the measuring pipe 1 to generate magnetic field in the direction orthogonal to both the pipe axis and an axis connecting a pair of the detecting electrodes.

A convex portion 7 made of non-magnetic metal with a height not less than the thickness of the lining material 4 is provided on the inner wall at the flange 1a position of the measuring pipe 1 integrally, the lining material 4 is lined so that the convex portion 7 contacts with the liquid, and the convex portion 7 is made as an earth electrode. The convex portion 7 can also be in contact with the outer non-magnetic metal portion of measuring pipe 1, providing a common ground between the liquid to be measured and the electronic flow meter.

In addition, the convex portions 7 are provided by not less than one, a plurality of numbers, at both end portions of the measuring pipe 1, respectively, and a groove 7a is processed at the outer circumference portion of the convex portion 7 except at the liquid contacting face, so as to lock the lining material 4.

In addition, with respect to material for each portion, materials are selected arbitrarily according to the fluid to be measured, for example, highly corrosion-resistant non-magnetic metal, such as SUS, is used for the measuring pipe 1, the convex portion and the detecting electrode 6, and rubber or fluorine resin is used for the lining material 4.

In addition, the convex portion 7 is made of the same metal as the material of the measuring pipe 1, and is fixed to the measuring pipe 1 directly by welding or by screw.

According to the first embodiment like this, as the size and diameter of the convex portion 7 can be arbitrarily changed according to the size of the pipe diameter of the measuring pipe 1, and in addition as the number of the convex portions 7 and the position in the pipe axis direction and the pipe circumference direction can be arbitrarily selected, not only it is possible to eliminate the use of the earth ring, but also it is possible to select the earthing condition according to the electric conductivity of the fluid to be measured and the bore diameter of the detector of the electromagnetic flow meter.

In addition, as the convex portion 7 is provided the end portion of the measuring pipe 1 just under the flange 1a, and the earthing structure to penetrate through the measuring pipe 1 is not employed, sealing between the lining material 4 and the inner wall face of the measuring pipe 1 can be made easily, and in addition, as the groove 7a is processed at the outer circumference portion of the convex portion 7 except at the liquid contacting face, the construction can be made that the lining material 4 can be locked to the groove 7a.

### Second Embodiment

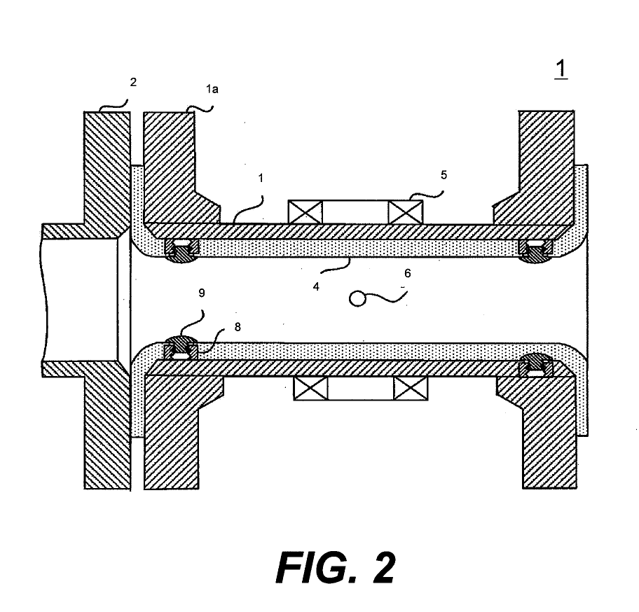

A second embodiment of the present disclosure will be described with reference to FIG. 2. With respect to each portion of the electromagnetic flow meter shown in FIG. 2, the same reference numeral is given to the same portion as each portion of the electromagnetic flow meter shown in FIG. 1, and its description will be omitted.

The point of the second embodiment shown in FIG. 2 which is different from the first embodiment shown in FIG. 1 is that in place of the convex portion 7 of the first embodiment, the convex portion of the second embodiment is provided with a boss 8 to be fixed to the measuring pipe 1 and a bar screw 9 to be screwed into the boss 8, and screw hole is processed at the inner face of the boss 8, and here a height of the boss 8 is set not more than the thickness of the lining material.

And, after the lining material 4 is lined, the screw is secured to the screw hole of the boss 8 from the inner face side of the measuring pipe 1 so as to lock the lining material 4, while the screw 9 is made as the earth electrode.

In this case, the screw 9 may be a general-purpose screw, but with respect to the screw neck, the liquid contacting face is fabricated in the curved structure in the same way as the detecting electrode 6 so as not to hinder the flow of the liquid to be measured.

The structure of the earth electrode like this forms the structure in which the lining material 4 can be locked by the screw 9.

### Third Embodiment

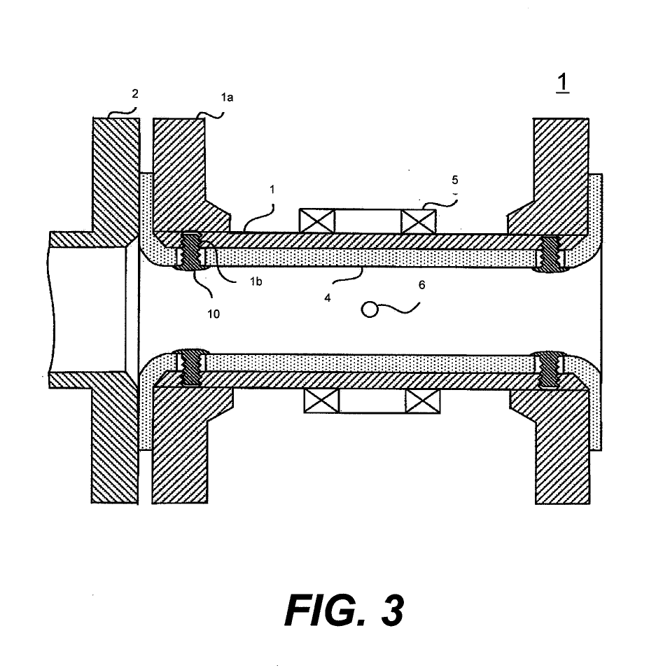

A third embodiment of the present disclosure will be described with reference to FIG. 3. With respect to each portion of the electromagnetic flow meter shown in FIG. 3, the same reference numeral is given to the same portion as each portion of the electromagnetic flow meter shown in FIG. 1, and its description will be omitted.

The point of the third embodiment shown in FIG. 3 which is different from the first embodiment shown in FIG. 1 is that in place of the convex portion 7 of the first embodiment, the third embodiment processes, not less than one, a plurality of screw holes lb at the inner wall positions of the both end portions of the measuring pipe 1, respectively, and after the lining material 4 is lined, screws 10 are secured to the screw holes 1b from the inner face side of the measuring pipe 1 so as to lock the lining material 4, while the screws 10 are made as the earth electrodes.

In this case, the screw 10 may be a general-purpose screw, but with respect to the screw neck, the liquid contacting face is fabricated in the curved structure in the same way as the detecting electrode 6 so as not to hinder the flow of the liquid to be measured.

The structure of the earth electrode like this forms the structure in which the lining material 4 can be locked by the screw 10.

The present disclosure is not limited to the above-described embodiments at all. The number and shape of the convex portions which become the earthing electrodes may be changed arbitrarily from the condition required by the electric conductivity of the fluid to be measured or the bore diameter of the measuring pipe, and the present disclosure can be embodied in various modifications within the scope without departing the spirit of the present disclosure.

What is claimed is:

1. An apparatus comprising:
a measuring pipe comprising an inner layer and a non-magnetic outer layer;
an electric flow meter electrically connected to the outer layer of the measuring pipe and operable to measure the flow of a material within the pipe;
at least one insert comprising non-magnetic material exposed to the interior space of the measuring pipe and in electrical connection with the outer layer of the measuring pipe, wherein the insert is operable to provide a common ground between the material within the pipe and the flow measuring device.

2. The apparatus of claim 1 wherein the electric flow meter comprises:
a pair of electrodes arranged opposite to one another along the inner layer of the measuring pipe so as to make contact with the material to be measured within the measuring pipe; and
a pair of exciting coils arranged on the outer layer of the measuring pipe operable to generate a magnetic field.

3. The apparatus of claim 1 wherein the measuring pipe comprises flanges located at ends of the measuring pipe and wherein the at least one insert is located at a position corresponding to the flanges.

4. The apparatus of claim 1 wherein the insert is in physical contact with the interior space of the measuring pipe and an outer layer of the measuring pipe.

5. The apparatus of claim 1 wherein the inner layer comprises a resin.

6. The apparatus of claim 5 wherein the insert is substantially the same thickness as the inner layer

7. The apparatus of claim 1 further comprising a boss formed in the inner surface of the measuring pipe and in physical contact with the outer layer wherein the insert is screwed into the boss.

8. The apparatus of claim 1 wherein the insert comprises the sole means operable to provide a common ground between the material within the pipe and the flow measuring device.

9. A method comprising:
generating a magnetic field in an orthogonal direction to a pipe axis, the pipe comprising an inner layer and an outer layer;
detecting changes in the generated magnetic field caused by material flow through the pipe using a magnetic flow meter;
electrically connecting the magnetic flow meter to the outer layer;
electrically connecting the material in the interior of the pipe to the outer layer of the pipe using at least one earth electrode insert that is fixed within the inner layer of the pipe wherein the insert is configured to be in physical contact with the interior space of the pipe and the outer layer of the pipe, and
determining the rate of flow of material within the pipe using the detected changes in the generated magnetic field.

10. The method of claim 9 wherein generating a magnetic field comprises operating a pair of exciting coils provided on an outer wall of the pipe in the direction orthogonal to the pipe axis.

11. The method of claim 9 wherein detecting changes in the generated magnetic field caused by material flow through the pipe comprises arranging a pair of detecting electrodes orthogonally to the axis of the pipe to face to each other at the inner faces of the measuring pipe so as to make contact with the material to be measured flowing in the measuring pipe.

12. The method of claim 9 wherein the insert comprises a boss and a screw, wherein the screw is screwed into the boss and is in physical contact with the material in the pipe and wherein the boss is in physical contact with the outer layer of the pipe.

13. The method of claim 9 wherein the pipe comprises first and second flanges located at first and second ends of the pipe and wherein at least one insert is provided at a location corresponding to the flanges.

14. The method of claim 9 wherein the at least one earth electrode insert comprises the sole means for electrically connecting the material in the interior of the pipe to the outer layer of the pipe.

15. An electromagnetic flow meter, comprising:
a measuring pipe formed with non-magnetic metal having flanges at the pipe's ends;
a lining material formed on an inner face of the measuring pipe;
a pair of detecting electrodes provided orthogonally to the axis of the measuring pipe to face to each other at the inner faces of the measuring pipe so as to make contact with a liquid to be measured flowing in the measuring pipe;
a pair of exciting coils provided on an outer wall of the measuring pipe operable to generate magnetic field in the direction orthogonal to both the pipe axis and an axis connecting the pair of the detecting electrodes; and
a convex portion made of non-magnetic metal with a height not less than a thickness of the lining material provided integrally on the inner wall of the measuring pipe at a position of the flange;
wherein the lining material is lined so that the convex portion contacts with the liquid and the non-magnetic metal portion of the measuring pipe, and the convex portion comprises an earth electrode.

16. The electromagnetic flow meter of claim 15 wherein the convex portions are provided at the end portions of the measuring pipe, and a groove is located at an outer circumference portion of the convex portion so as to lock the lining material.

17. The electromagnetic flow meter of claim 15 wherein the convex portion comprises a boss with a height not more than a thickness of the lining material, a screw, and a screw hole located at an inner face of the boss; wherein the screw comprises an earth electrode and is secured in the screw hole of the boss from the inner face side of the measuring pipe so as to lock the lining material.

18. The electromagnetic flow meter of claim 15 wherein the lining material of the measuring pipe comprises a resin.

19. The electromagnetic flow meter of claim 15 wherein the lining material of the measuring pipe comprises a plastic.

20. The electromagnetic flow meter of claim 15 wherein the convex portion comprises the sole means for electrically connecting the fluid to be measured to the non-magnetic metal portion of the measuring pipe.
